(19) United States
(12) Patent Application Publication
(10) Pub. No.: US 2019/0039936 A1
(43) Pub. Date: Feb. 7, 2019

(54) THERMALLY STRENGTHENED GLASS SHEETS HAVING CHARACTERISTIC MEMBRANE STRESS HOMOGENEITY

(71) Applicant: Corning Incorporated, Corning, NY (US)

(72) Inventors: Jeffrey John Domey, Elmira, NY (US); Dragan Pikula, Horseheads, NY (US); Robert Wendell Sharps, Corning, NY (US)

(21) Appl. No.: 16/073,936

(22) PCT Filed: Jan. 31, 2017
(86) PCT No.: PCT/US17/15736

§ 371 Date: Jul. 30, 2018

Related U.S. Application Data
(60) Provisional application No. 62/289,334, filed on Jan. 31, 2016.
(60) Provisional application No. 62/428,531, filed on Dec. 1, 2016.

(51) Int. Cl. C03B 27/016; C03B 27/04; C03B 29/08

(52) U.S. Cl. CPC C03B 27/016; C03B 27/048; C03B 29/08; C03B 27/0413

(57) ABSTRACT

A glass sheet thermally strengthened such that at the first major surface is under compressive stress; the sheet having an a characteristic 2D autocorrelation matrix c(x,y) given by c(x,y)=F⁻¹(F(g)·F̂(g)) where F is a 2D Fourier transform and ̂ represents a complex conjugate operation and g is a high pass filtered data array given by g(x,y)=F⁻¹(F(f(1−F(h)) where h is a spatial 2D low pass filter array and f is a square data array of Shear 0 and Shear 45 data, taken over an area away from any birefringence edge effects on the sheet, wherein an autocorrelation peak maximum width of the matrix c(x,y) at 40% of peak height, for the c(x,y) matrices from both the Shear 0 and Shear 45 data, is between 1 and 5 mm.

This application claims the benefit of priority of U.S. Provisional Application No 62/289,334, filed on Jan. 31, 2016, and U.S. Provisional Application No. 62/428,531, filed on Dec. 1, 2016 the contents of which are relied upon and incorporated herein by reference in their entirety.

This application is related to and hereby incorporates herein by reference in full the following applications: Provisional Application Ser. No. 62/288,177 filed on Jan. 28, 2016, U.S. Provisional Application Ser. No. 62/288,615 filed on Jan. 29, 2016, U.S. Provisional Application Ser. No. 62/428,142 filed on Nov. 30, 2016, and U.S. Provisional Application Ser. No. 62/428,168, filed on Nov. 30, 2016, U.S. Provisional Application Ser. No. 62/288,851, filed on Jan. 29, 2016, U.S. application Ser. No. 14/814,232, filed on Jul. 30, 2015; U.S. application Ser. No. 14/814,181, filed on Jul. 30, 2015; U.S. application Ser. No. 14/814,274, filed on Jul. 30, 2015; U.S. application Ser. No. 14/814,293, filed on Jul. 30, 2015; U.S. application Ser. No. 14/814,303, filed on Jul. 30, 2015; U.S. application Ser. No. 14/814,363, filed on Jul. 30, 2015; U.S. application Ser. No. 14/814,319, filed on Jul. 30, 2015; U.S. application Ser. No. 14/814,335, filed on Jul. 30, 2015; U.S. Provisional Application No. 62/031,856, filed Jul. 31, 2014; U.S. Provisional Application No. 62/074,838, filed Nov. 4, 2014; U.S. Provisional Application No. 62/031,856, filed Apr. 14, 2015; U.S. application Ser. No. 14/814,232, filed Jul. 30, 2015; U.S. application Ser. No. 14/814,181, filed Jul. 30, 2015; U.S. application Ser. No. 14/814,274, filed Jul. 30, 2015; U.S. application Ser. No. 14/814,293, filed Jul. 30, 2015; U.S. application Ser. No. 14/814,303, filed Jul. 30, 2015; U.S. application Ser. No. 14/814,363, filed Jul. 30, 2015; U.S. application Ser. No. 14/814,319, filed Jul. 30, 2015; U.S. application Ser. No. 14/814,335, filed Jul. 30, 2015; U.S. Provisional Application No. 62/236,296, filed Oct. 2, 2015; U.S. Provisional Application No. 62/288,549, filed Jan. 29, 2016; U.S. Provisional Application No. 62/288,566, filed Jan. 29, 2016; U.S. Provisional Application No. 62/288,615, filed Jan. 29, 2016; U.S. Provisional Application No. 62/288,695, filed on Jan. 29, 2016; U.S. Provisional Application No. 62/288,755, filed on Jan. 29, 2016.

### FIELD

This disclosure relates to generally to improved thermally tempered glass and more specifically to thermally strengthened glass sheets having high homogeneity of membrane stresses.

### BACKGROUND

Commonly-assigned U.S. Pat. No. 9,296,638 (the '638 patent) entitled “Thermally Tempered Glass and Method and Apparatuses for Thermal Tempering of Glass” discloses methods and apparatuses for heating and/or thermally tempering glass sheets. The contents of the '638 patent are relied upon and incorporated herein by reference in their entirety for purposes of U.S. law.

### DEFINITIONS

The phrases “glass sheet(s)” and “glass ribbon(s)” are used broadly in the specification and in the claims and include sheet(s) and ribbon(s) that comprise one or more glasses and/or one or more glass-ceramics, as well as laminates or other composites that include one or more glass and/or one or more glass-ceramic components. The phrase “glass sheet(s)” is used to refer to glass sheet(s) and glass ribbon(s) collectively. “Glass” includes glass and materials known as glass ceramics.

### SUMMARY

The present disclosure provides additional features or enhancements relative to the methods and apparatuses for the production of thermally strengthened glass of the '638 patent which, together with the methods and apparatuses of the '638 patent provide for the production of thermally strengthened glass having improved homogeneity of membrane stress.

According to embodiments, a strengthened glass sheet has first major surface, a second major a thickness t when expressed in mm between the major surfaces; a length of l when expressed in mm of at least 10; a width of w when expressed in mm of at least 10; an interior region located between the first and second major surfaces; and an outer edge surface extending between and surrounding the first and second major surfaces such that the outer edge surface defines a perimeter of the sheet; wherein the sheet is thermally strengthened such that at the first major surface is under compressive stress; the sheet having an a characteristic 2D autocorrelation matrix c(x,y) given by c(x,y)=F⁻¹(F(g)·\hat{F}(g)) where F is a 2D Fourier transform and ̂ represents a complex conjugate operation and g is a high pass filtered data array given by g(x,y)=F⁻¹(F(f)(1−F(h))) where h is a spatial 2D low pass filter array and f is a square data array of Shear 0 and Shear 45 data, taken over an area away from any birefringence edge effects on the sheet, wherein an autocorrelation peak maximum width of the matrix c(x,y) at 40% of peak height, for the c(x,y) matrices from both the Shear 0 and Shear 45 data, is between 1 and 5 mm.

According to embodiments, the autocorrelation peak maximum width of the matrix c(x,y) at 40% of peak height, is between 1 and 4 mm, 1 and 3 mm, or even 1 and 2 mm or less.

According to embodiments, the Ra roughness, measured over an area on the first major surface of 10 μm×10 μm according to the standard of ISO 19606, can be in the range of from 0.05 or 0.1 nm to 20, 4, 0.8, 0.7, 0.6, 0.5, 0.4, 0.3 or even as low as to 0.2 nm Ra.

According to embodiments, a normalized standard deviation S,

$${S}_{n} = \frac{s}{\overline{x}}$$

of a sample of membrane stress measurement samples taken according to ASTM F218 in transmission through the first major surface 12 of the sheet 10 in a series distributed in the x and y directions for number of samples N=100, is low (when edge effects of measuring too close—i.e., within 2.5 times the thickness of the sheet to the outer edge surface 16 are not included)—as low as 0.02, 0.015, 0.01, 0.005, 0.002, 0.001 or even lower.

The reference characters used are only for the convenience of the reader and are not intended to and should not be interpreted as limiting the scope of the invention. More generally, it is to be understood that both the foregoing general description and the following detailed description are merely exemplary of the invention and are intended to provide an overview or framework for understanding the nature and character of the invention.

Additional features and advantages of the invention are set forth in the detailed description which follows, and in part will be readily apparent to those skilled in the art from that description or recognized by practicing the invention as exemplified by the description herein. The accompanying drawings are included to provide a further understanding of the invention, and are incorporated in and constitute a part of this specification. It is to be understood that the various features of the invention disclosed in this specification and in the drawings (which are not to scale) can be used individually and in any and all combinations.

### BRIEF DESCRIPTION OF THE DRAWINGS

FIG. 1 is a schematic cross sectional side view drawing of an embodiment of a heat sink or source for heating or cooling a glass sheet.

FIG. 2 is a schematic cross sectional side view drawing of an embodiment of an apparatus for heating and then quenching glass sheets.

FIG. 3 is a schematic cross-sectional plan view drawing of an embodiment of a heat source.

FIG. 4 is a perspective view drawing of an sheet or sheet comprising glass.

FIG. 5 is a schematic cross sectional side view drawing of an embodiment of a heat sink or source.

FIG. 6 is a schematic cross sectional side view drawing of another embodiment of a heat sink or source.

FIGS. 7A and 7B show a representative example result of 2D autocorrelation of a non-uniform sample.

FIGS. 8A and 8B show a representative example result of 2D autocorrelation of a highly uniform sample.

### DETAILED DESCRIPTION

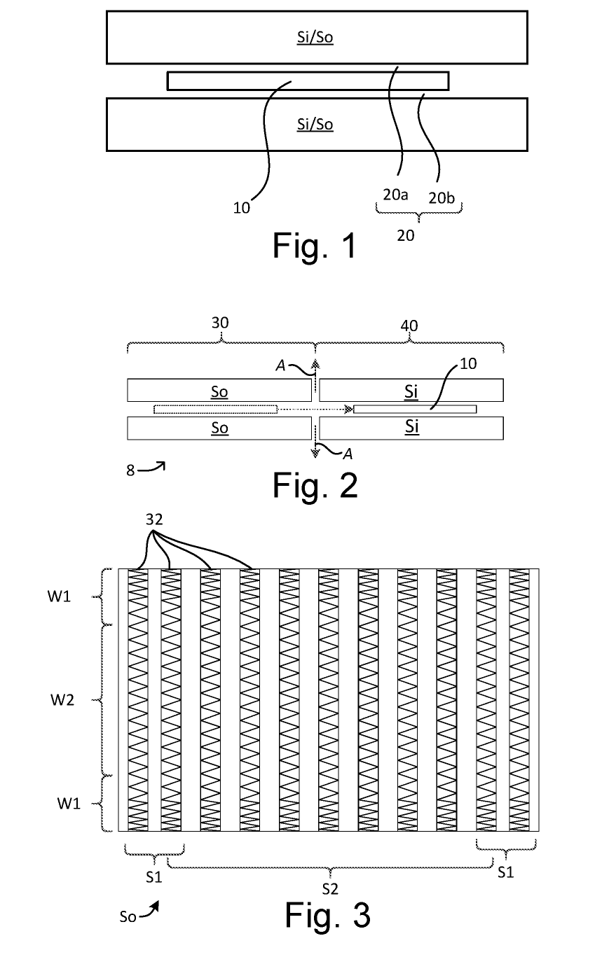

FIG. 1 is a schematic cross sectional side view drawing of an embodiment of an arrangement of a pair of heat sinks or sources Si/So for heating or cooling a glass sheet 10. Thin gaps 20 between the sheet 10 and the heat sinks or sources Si/So contain a gas through which heat is conducted to heat or cool the sheet 10 such that at least 20% of the total heating or cooling is by conduction, desirably 30, 40, 50, 60, and even 70, 80 or 90% or more. The sheet 10 is supported between the two sinks or sources Si/So by any suitable and most preferably non-contact means, including such alternatives as ultrasonic energy, electrostatic forces, but preferably by gas bearings formed in the gaps 20 (comprising first gap 20a and second gap 20b).

The sheet 10 can be stationary or in motion between the sinks or sources Si/So. The sheet 10 can be smaller (in one dimension or both) than the extent of the sinks or sources Si/So or larger (preferably in one dimension only, in which case continuous processing in the larger direction is preferred). The sheet 10 can be multiple sheets heated or cooled together at the same time. The gas in the first and second gaps 20a and 20b can be the same or different, and both or either can be gas mixtures or essentially pure gases. Generally, gases or gas mixtures with relatively higher thermal conductivity are preferred. Use of gas bearings allows robustly maintaining the desired size of the gaps 20a and 20b, which enables relatively homogeneous heat transfer rates over all areas of the gaps 20, in comparison to cooling or heating by direct contact with liquids or with solids, and in comparison to cooling by forced air convection.

As represented in the diagrammatic cross section of FIG. 2, a thermal tempering or strengthening apparatus 8 generally includes both a heating zone 30 and a cooling zone 40, and both can be in the form of a pair of heat sources So or a pair of heat sinks Si, separated from the sheet by thin gas gaps 20 as in FIG. 1. As an alternative, the heating zone may be in the form of a conventional furnace or oven rather than the thin-gap arrangement of heat sources So shown here. In general terms, heating zone 30 heats the glass sheet(s) to a temperature sufficient for thermal strengthening, and the cooling zone 40 lowers the temperature of the sheet(s) by removing heat through the surfaces of the sheet(s) at a rate sufficient and for a sufficient time to achieve a desired level of thermal strengthening when the sheet(s) are (later) finally at ambient temperatures. A sheet 10 is heated to a sufficient temperature for generating temper effects (generally between the glass transition point and the softening point of the glass), and is cooled in the cooling zone. Transport may be by any suitable means.

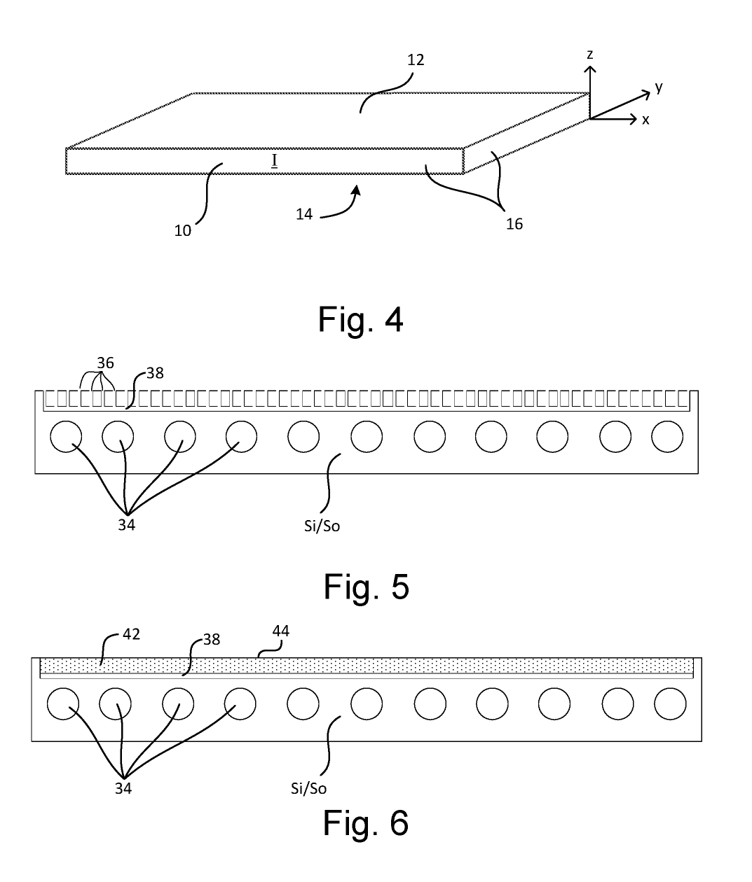

FIG. 4 shows a perspective view of the sheet 10 comprising glass, which includes a first major surface 12, a second major surface 14 opposite the first (obscured in the view of FIG. 3), an interior region I located between the first and second major surfaces, and an outer edge surface 16 extending between and surrounding the first and second major surfaces such that the outer edge surface defines the perimeter of the sheet. x-y-z coordinates are shown for ease of reference, with z in the thickness direction.

Gas bearings, as alternative embodiments, may take either of the forms shown in FIGS. 5 and 6. FIG. 5 is a schematic cross sectional side view drawing of one embodiment of a heat sink or source Si/So, and FIG. 6 is a schematic cross sectional side view drawing of another embodiment of a heat sink or source Si/So. In both of these embodiments, the circular structures are thermal control structures 34, such as cartridge heaters if the embodiment is a heat source So, or such as coolant passages if the embodiment is a heat sink Si. The embodiment of FIG. 5 employs discrete holes 36 through which gas can be fed from a plenum 38. The embodiment of FIG. 6 includes a porous structure 42 through which gas can likewise be fed from a plenum 38, with the effect that the gas is emitted essentially from every portion of the surface 44 of the porous structure 42.

Because of the non-contact treatment and handling possible in the thermal strengthening apparatus of FIG. 2, by using gas bearings such as in FIGS. 5 and 6 or by other suitable non-contact means, the first major surface 12 of the sheet 10 can have very low roughness, achieved by preserving the as-floated quality of the “air side” of float glass, or the as-drawn quality of either side of fusion-drawn glass. The Ra roughness, measured over an area on the first major surface of 10 μm×10 μm according to the standard of ISO 19606, can be in the range of from 0.05 or 0.1 nm to 20, 4, 0.8, 0.7, 0.6, 0.5, 0.4, 0.3 or even as low as to 0.2 nm Ra. The self-restoring or self-centering effects of opposing gas bearings can also assist in keeping thin glass sheets flat, even very thin sheets. Thin sheets with thicknesses within in the range of from 0.1, 0.2 or 0.5 mm to 3, 2.8, 2.6, 2.4, 2.2, 2.0, 1.8, 1.6, 1.4, 1.2, 1.1, 1, 0.9, 0.8, 0.7, 0.6 mm can be processed, as well as thicker sheets.

Achieving uniformity of cooling effects in the cooling zone 40 over the area of the sheet 10 requires maintaining the desired size of the gaps 20. It has also been found that maintaining the homogeneity of the gas in the gaps 20a, 20b within the cooling zone is important. If different gases are used in the heat source So gaps and the heat sink Si gaps, gas can be drawn away by a suitable suction or vacuum means at a position between the sources So and the sinks Si, as indicated by the arrows A in FIG. 2, so that the differing gases do not mix within the heat sinks Si of the cooling zone (or within the heat sources So). Alternatively and optionally, a transition zone such as is disclosed in the '638 patent, positioned between the heating and cooling zone, can include a feed of the same gas as in the cooling zone and can physically isolate the heating zone gas from the cooling zone gas in the case that they are different. Interestingly, and in contrast to forced convective gas tempering, when the gases are the same and conduction is the dominating heat transfer mode, any hot gas traveling with the sheet 10 from hot zone 30 to cold zone 40 is not a very significant factor in the process, since the thermal mass of the gas is negligible relative to the effects of conduction.

For good homogeneity of heat transfer rates during heating and resulting homogeneous temperature profiles and final properties of sheet 10, it is also desirable to provide a heat source So providing for a non-uniform distribution of heating energy. FIG. 3 shows diagrammatic cross sectional plan view of a heat source So such as those of FIGS. 1 and 2, having such a non-uniform distribution of heating energy in the form of cartridge heaters 32 distributed within the heat source So. A first spacing S1 of the cartridge heaters near the left and right edges of the heat source So in the figure is closer than a second spacing S2 of the cartridge heaters in the more central region of the heat source So. This has the effect, desired in most circumstances, of balancing thermal losses to the ambient environment at the left and right edges of the heat source So. Similarly, the windings within the cartridge heaters 32 can have a first average winding density W1 near the edges (top and bottom in the figure) of the heat source So greater than a second average winding density W2 in the more central region of the heat source So.

With good control of the thermal profile of the sheet just before cooling, such as may be achieved by the heat source So of FIG. 3 or by other suitable means, and with steps taken to prevent unwanted gas mixing in the heat sink Si, as described in connection with FIG. 2 or by other suitable means, thermally strengthened sheets comprising glass and/or glass ceramic can be produced having very good quality, especially relative to the achieved strengthening as a function of glass thickness and glass properties. In particular, the improved properties can include improved homogeneity of membrane stresses.

For example, an sheet processed according to this disclosure in combination with the disclosure of the '638 patent can achieve a desirable low deviation of membrane stress, such that a normalized standard deviation Sₙ

$${S}_{n} = \frac{s}{\overline{x}} \qquad ( 1 )$$

of a sample of membrane stress measurement samples taken according to ASTM F218 in transmission through the first major surface 12 of the sheet 10 in a series distributed in the x and y directions for number of samples N=100, is low (when edge effects of measuring too close—i.e., within 2.5 times the thickness of the sheet to the outer edge surface 16 are not included)—as low as 0.02, 0.015, 0.01, 0.005, 0.002, 0.001 or even lower.

### Membrane Stress Cross-Correlation Analysis

Measurement

A full-field polarimeter is used to make optical birefringence measurements, through the thickness of the sample, of retardation magnitude and slow-axis azimuth. The optical axis of the polarimeter is aligned to the desired coordinate axis of the sample. Multiple point measurements are made on an equal spaced XY grid, so that a 2D map of birefringence is generated for the sample. Grid spacing is sufficiently small so that the number of steps in X and Y is many, for example, at least 100 in both X and Y (after data from within 2.5 times sheet thickness of the edge is excluded) is generally adequate for the test: more is desirable to improve resolution but generally will not significantly impact results. The grid size is also selected to be large enough spatially to capture any spatially periodic features in the data.

Data Processing

First, the optical birefringence values of magnitude and azimuth are converted into the two shear stress components of Shear 0 (“S0”) and Shear 45 (“S45”) by the equations m·cos(2az) and m·sin(2az), respectively, as understood by those of skill in the art of stress calculation through birefringence measurement. S0 and S45 may be calculated directly by the software of an instrument which also first measures the multiple birefringence values in X and Y, such as a grey-field polarimeter (“GFP”) from Stress Photonics USA. The results of this operation are two 2D arrays, one of S0 values and the other of S45 values. S0 and S45 typically both have units of nanometers, and both can be treated as scalar values for the purposes of direct mathematical arithmetic.

As understood by those of skill in the art, if desired for purposes of visualization or other analysis, the S0 and S45 values may be converted into the in-plane components of principal stress, S1 and S2. The results of this operation are two 2D arrays, one of S1 values and the other of S2 values.

Data Analysis: 2D Autocorrelation Lengths

For input into this analysis, the two 2D arrays of S0 and S45 are used. For each of the 2D arrays separately, we: (1) Extract a sub-array dataset in which the number of columns and rows are equal (i.e., the sub-array is square). The extraction area should be away from the sample edge (by at 2.5 times the sheet thickness, preferably 3 times according to one embodiment, 4 times according to another) in order to avoid edge effects in the measured data. As mentioned, the sub-array dataset must have a minimum number of rows and columns, at least 100 each, so that the subsequent mathematical operations can be robustly applied. (2) Filter the data through a 2D high-pass spatial filtering process to remove spatial frequencies less than about one cycle per array width, effectively removing spatial variations such as slope or tilt of the data. This may be performed in two steps, namely, (a) apply a 2D low-pass spatial filter to the sub-array dataset to remove the high frequency components above a desired cutoff frequency, and (b) subtract from the unfiltered sub-array dataset the filtered sub-array dataset, to generate the high-pass filtered sub-array dataset. (4) Perform a 2D auto-correlation on the high-pass filtered sub-array dataset.

To describe these steps formulaically, we can represent our starting 2D array (for both S0 and S445 date sets) by f(x,y), our high pass array by g(x,y), our spatial 2D low pass filter array by h(x,y), and is our autocorrelation array by c(x,y). The filter h(x,y) is defined as

$$h ( x , y ) = {e}^{- \frac{( {x}^{2} + {y}^{2} ) l n ( 2 )}{{10}^{2}}} \qquad ( 2 )$$

within a square −1/2W_{f}≤x,y≤1/2W_{f} and zero outside the square, where W_{f} is the filter width. Filter components are normalized to sum to 1 so that the filter produced no gain. We use F( ) and F⁻¹( ) to denote 2D Fourier and 2D inverse Fourier transforms, respectively. Also, for this discussion, “·” will represent array multiplication and “̂” will represent the complex conjugate operation. Then g(x,y) is given by

g(x,y)=F⁻¹(F(f)(1−F(h))) (3)

and the 2D auto correlation matrix is given by

c(x,y)=F⁻¹(F(g)·\hat{F}(g)) (4)

The resulting 2D autocorrelation sub-array dataset c(x,y) will contain a central peak with relative amplitude of 1. The cross-section of this peak will not generally be circular, but rather elliptical in shape with minimum and maximum diameters in units of distance. At a desired relative amplitude level (height) (e.g., at 0.4), the minimum and maximum diameters of the central peak (in whatever direction they lie) can be extracted to record as autocorrelation lengths.

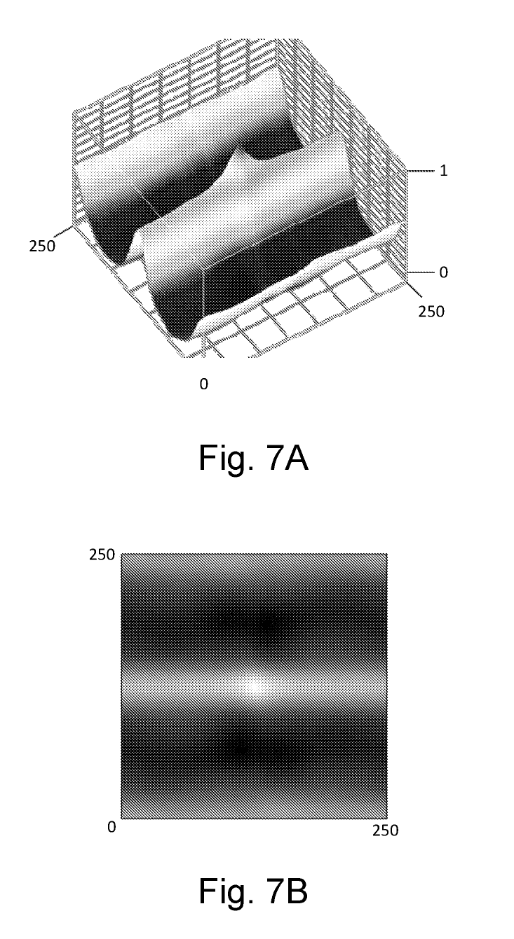

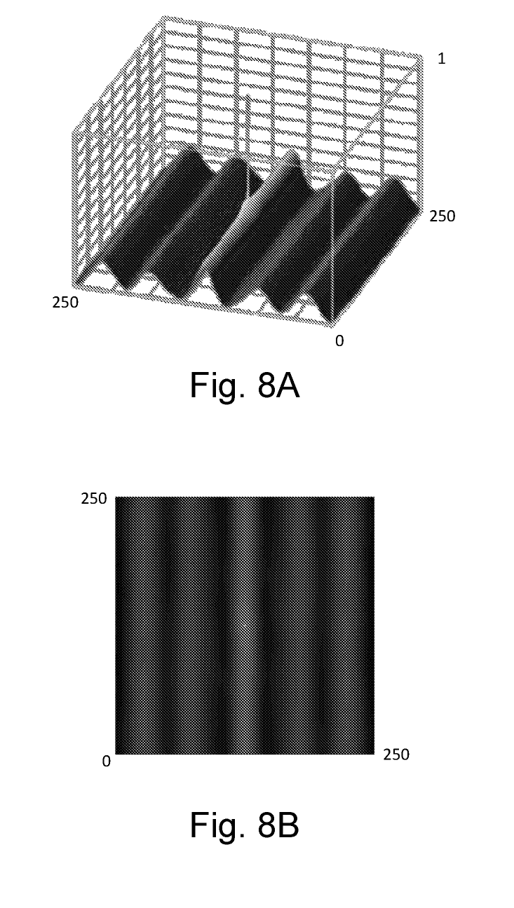

FIGS. 7A and 7B show a representative example result of 2D autocorrelation of a non-uniform sample, with a plane view of the data shown in FIG. 7B, and an oblique view of the same data in FIG. 7A. The unit axes in the plane are in millimeters, with the cross correlation peak on a unit scale of 1. The central peak and its varying diameter is particularly visible particularly in FIG. 7A. FIGS. 8A and 8B show a representative example result of 2D autocorrelation of a highly uniform sample, with a plane view of the data shown in FIG. 7B, and an oblique view of the same data in FIG. 7A. The central peak, which is almost as narrow as the resolution of the data allows, is particularly in FIG. 7A.

Comparison of multiple sheets of the present disclosure with multiple samples of sheets produced using conventional forced-air convention cooling has shown that autocorrelation peak maximum width at 40% of peak height (at height of 0.4), for both the Shear 0 and Shear 45 data sets, is between 1 and 5 mm, indicating relatively weak periodic non-uniformity in the birefringence and membrane stress of the sheet. Sheets produced using conventional forced-air convention cooling have significantly larger autocorrelation widths at height of 0.4, indicating stronger periodic non-homogeneity in the retardance and membrane stress of the sheet.

A variety of modifications that do not depart from the scope and spirit of the invention will be evident to persons having ordinary skill in the art from the foregoing disclosure.

1. A strengthened glass sheet, the sheet comprising
first major surface;
a second major surface opposite the first major surface and separated from the first major surface by a thickness t when expressed in mm;
a length of l when expressed in mm of at least 10;
a width of w when expressed in mm of at least 10;
an interior region located between the first and second major surfaces; and
an outer edge surface extending between and surrounding the first and second major surfaces such that the outer edge surface defines a perimeter of the sheet;
wherein the sheet is thermally strengthened such that at the first major surface is under compressive stress;
the sheet having an a characteristic 2D autocorrelation matrix c(x,y) given by
c(x,y)=F⁻¹(F(g)·\hat{F}(g))
where F is a 2D Fourier transform and ̂ represents the complex conjugate operation and g is a high pass filtered data array given by
g(x,y)=F⁻¹(F(f)(1−F(h)))
where h is a spatial 2D low pass filter array and f is a square data array of Shear 0 and Shear 45 data, taken over an area away from any birefringence edge effects on the sheet, wherein an autocorrelation peak maximum width of the matrix c(x,y) at 40% of peak height, for the c(x,y) matrices from both the Shear 0 and Shear 45 data, is between 1 and 5 mm.

2. The sheet according to claim 1 wherein the autocorrelation peak maximum width of the matrix c(x,y) at 40% of peak height, for the c(x,y) matrices from both the Shear 0 and Shear 45 data, is between 1 and 4 mm.

3. The sheet according to claim 1 wherein the autocorrelation peak maximum width of the matrix c(x,y) at 40% of peak height, for the c(x,y) matrices from both the Shear 0 and Shear 45 data, is between 1 and 3 mm.

4. The strengthened glass sheet according to claim 1, wherein the first major surface of the sheet has a roughness, measured over an area on the first major surface of 10 μm×10 μm, is in the range of from 0.05 nm to 0.5 nm Ra.

5. The strengthened glass sheet according to claim 1, wherein the first major surface of the sheet has a roughness, measured over an area on the first major surface of 10 μm×10 μm, is in the range of from 0.05 nm to 0.3 nm Ra.

6. The strengthened glass sheet according to claim 1, wherein a normalized standard deviation Sₙ
$${S}_{n} = \frac{s}{\overline{x}}$$
of membrane stress measurement samples taken through the first and second major surfaces 12, 14 the sheet 10 in a series distributed equally in the x and y directions, but not within a distance of 2.5 times the thickness of the sheet to the outer edge surface 16, for number of samples N=100, is less than or equal to 0.02.

7. A strengthened glass sheet according to claim 6, wherein said normalized standard deviation Sₙ is less than or equal to 0.002.

8. A strengthened glass sheet according to claim 6, wherein said normalized standard deviation Sₙ is less than or equal to 0.001.

9. A strengthened glass sheet, the sheet comprising
first major surface;
a second major surface opposite the first major surface and separated from the first major surface by a thickness t when expressed in mm;
a length of l when expressed in mm of at least 10;
a width of w when expressed in mm of at least 10;
an interior region located between the first and second major surfaces; and
an outer edge surface extending between and surrounding the first and second major surfaces such that the outer edge surface defines a perimeter of the sheet;
wherein the sheet is thermally strengthened such that at the first major surface is under compressive stress;
wherein a normalized standard deviation Sₙ
$${S}_{n} = \frac{s}{\overline{x}}$$
of membrane stress measurement samples taken through the first and second major surfaces 12, 14 the sheet 10 in a series distributed equally in the x and y directions, but not within a distance of 2.5 times the thickness of the sheet to the outer edge surface 16, for number of samples N=100, is less than or equal to 0.02.

10. A strengthened glass sheet according to claim 9, wherein said normalized standard deviation Sₙ is less than or equal to 0.002.

11. A strengthened glass sheet according to claim 9, wherein said normalized standard deviation Sₙ is less than or equal to 0.001.

12. A strengthened glass sheet according to claim 9, wherein the sheet has a characteristic 2D autocorrelation matrix c(x,y) given by
c(x,y)=F⁻¹(F(g)·\hat{F}(g))
where F is a 2D Fourier transform and ̂ represents the complex conjugate operation and g is a high pass filtered data array given by
g(x,y)=F⁻¹(F(f)(1−F(h)))
where h is a spatial 2D low pass filter array andfis a square data array of Shear 0 and Shear 45 data, taken over an area away from any birefringence edge effects on the sheet, wherein an autocorrelation peak maximum width of the matrix c(x,y) at 40% of peak height, for the c(x,y) matrices from both the Shear 0 and Shear 45 data, is between 1 and 5 mm.

13. The sheet according to claim 12 wherein the autocorrelation peak maximum width of the matrix c(x,y) at 40% of peak height, for the c(x,y) matrices from both the Shear 0 and Shear 45 data, is between 1 and 4 mm.

14. The sheet according to claim 12 wherein the autocorrelation peak maximum width of the matrix c(x,y) at 40% of peak height, for the c(x,y) matrices from both the Shear 0 and Shear 45 data, is between 1 and 3 mm.

15. The strengthened glass sheet according to claim 9, wherein the first major surface of the sheet has a roughness, measured over an area on the first major surface of 10 μm×10 μm, is in the range of from 0.05 nm to 0.5 nm Ra
